(19) United States
(12) Patent Application Publication
(10) Pub. No.: US 2026/0299775 A1
(43) Pub. Date: Oct. 1, 2026

(54) MEDICAL DEVICE AND DISPLAY SETTING METHOD

(71) Applicant: FUKUDA DENSI CO., LTD., Tokyo (JP)

(72) Inventors: Yuichi YAZAWA, Tokyo (JP); Shohei ARAKI, Tokyo (JP); Yuhei SUGAI, Tokyo (JP)

(73) Assignee: FUKUDA DENSI CO., LTD., Tokyo (JP)

(21) Appl. No.: 19/577,395

(22) Filed: Mar. 25, 2026

(30) Foreign Application Priority Data
Mar. 28, 2025 (JP) 2025-056739

(51) Int. Cl. G06F 3/04847; G06F 3/04845

(52) U.S. Cl. CPC G06F 3/04847; G06F 3/04845; G06F 2203/04803

(57) ABSTRACT

A medical device includes a controller configured to receive first input that specifies biological information to be displayed on a screen, display, on the screen, a plurality of display size candidates corresponding to the biological information specified by the first input, receive second input that specifies one display size from the plurality of display size candidates, arrange, on the screen, a display area of the display size specified by the second input, in such a manner that the display area aligns to a grid set in advance, and display the biological information specified by the first input within the display area.

### BACKGROUND

The present disclosure relates to a medical device and a display setting method.

Japanese Patent Laid-Open No. 2023-118584 discloses a medical device such as a bedside monitor that can display biological information of a patient or the like. In addition, as such a medical device, one is known which allows the specification of biological information that is to be displayed on a screen and the specification of a display size of the biological information on the screen.

### SUMMARY

A displayable size is set in advance for each piece of biological information on a biological information monitor. However, display information does not clearly indicate to which display size each piece of biological information corresponds. Hence, there is no method to check to which display size biological information corresponds, before a setting is actually made.

It is accordingly an object of the present disclosure to make it possible to check what size biological information can be displayed on a display screen of a medical device.

In order to solve the above problem, according to the present disclosure, there is provided a medical device including a controller configured to receive first input that specifies biological information to be displayed on a screen, display, on the screen, a plurality of display size candidates corresponding to the biological information specified by the first input, receive second input that specifies one display size from the plurality of display size candidates, arrange, on the screen, a display area of the display size specified by the second input, in such a manner that the display area aligns to a grid set in advance, and display the biological information specified by the first input within the display area.

### BRIEF DESCRIPTION OF THE DRAWINGS

FIG. 1 is a block diagram illustrating an example of a display system including a medical device according to one embodiment of the present disclosure;

FIG. 2 is a flowchart illustrating an example of a display setting process performed by a processor of the medical device according to the present embodiment;

FIG. 3 is a flowchart illustrating an example of an addition process performed by the processor of the medical device according to the present embodiment;

FIG. 4 is a flowchart illustrating an example of a resizing process performed by the processor of the medical device according to the present embodiment;

FIG. 5 is a diagram illustrating an example of a display screen displayed on a touch panel of the medical device according to the present embodiment;

FIG. 6 is a diagram illustrating an example of a setting screen displayed on the touch panel of the medical device according to the present embodiment;

FIG. 7 is a diagram illustrating an example of a setting screen displayed on the touch panel of the medical device according to the present embodiment;

FIG. 8 is a diagram illustrating an example of a setting screen displayed on the touch panel of the medical device according to the present embodiment; and

FIG. 9 is a diagram illustrating an example of a setting screen displayed on the touch panel of the medical device according to the present embodiment.

### DETAILED DESCRIPTION OF THE PREFERRED EMBODIMENT

One embodiment of the present disclosure will hereinafter be described in detail with reference to the accompanying drawings. Concrete dimensions, materials, numerical values, and the like illustrated in the embodiment are merely illustrative for the purpose of facilitating the understanding of the disclosure, and do not limit the present disclosure except where specifically noted. Incidentally, in the present specification and the drawings, elements having substantially the same functions or configurations are assigned the same reference signs, and repeated description will thereby be omitted. In addition, elements not directly related to the present disclosure are not illustrated.

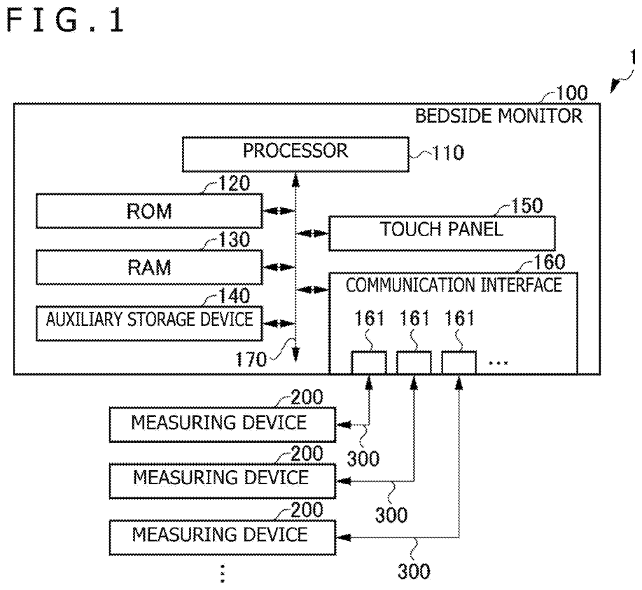

FIG. 1 is a block diagram illustrating an example of a display system 1 including a medical device according to the one embodiment of the present disclosure. Incidentally, each constituent element of each device may be internal or may be external. The display system 1 is a system that displays biological information of a patient or the like. The biological information is information about a living body of a subject. The biological information may be, for example, information about a living body of a patient in a medical institution such as a hospital. The biological information includes, for example, at least one or more of a respiration rate, a body temperature, a blood pressure, a heart rate, a pulse rate, an electrocardiogram, and an oxygen saturation (SpO₂) in blood. However, the biological information is not limited to this and may include various kinds of information related to a living body of a patient. A medical worker (for example, a doctor or a nurse) in a medical institution such as a hospital can perform a procedure according to the symptom and conditions of a patient by checking the biological information of the patient displayed on a bedside monitor 100 in real time. The display system 1 includes, for example, the bedside monitor 100 and a plurality of measuring devices 200. It is to be noted that it is sufficient if the display system 1 includes one or a plurality of kinds of medical devices. For example, the display system 1 may not include the measuring devices 200 or may include another device.

The bedside monitor 100 is a medical device that displays at least one kind of biological information measured by the measuring devices 200, within a box arranged on a screen of the bedside monitor 100. The bedside monitor 100 has a function of customizing the arrangement of the box on the screen. In addition, the bedside monitor 100 has a function of displaying display size candidates for the box which are set in advance for each piece of biological information. Incidentally, the bedside monitor 100 is an example of the medical device according to the present disclosure.

The bedside monitor 100 includes, for example, a processor 110, a read-only memory (ROM) 120, a random-access memory (RAM) 130, an auxiliary storage unit 140, a touch panel 150, and a communication interface 160. Further, these parts are connected to one another by a bus 170 and the like.

The processor 110 is a central part of a computer that performs such processing as computation and control necessary for the operation of the bedside monitor 100. The processor 110 is a circuit that performs various kinds of computation, processing, and the like. The processor 110 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), a field-programmable gate array (FPGA), or the like. Alternatively, the processor 110 is a combination of a plurality of these. In addition, the processor 110 may be obtained by combining a hardware accelerator or the like to these. The processor 110 controls various parts to implement various kinds of functions of the bedside monitor 100 on the basis of programs such as firmware, system software, and application software stored in the ROM 120, the auxiliary storage unit 140, or the like. In addition, the processor 110 performs processing to be described later on the basis of the programs. Incidentally, some or all of the programs may be incorporated in the circuit of the processor 110. Incidentally, the processor 110 is an example of a controller.

The ROM 120 and the RAM 130 serve as a main storage unit of the computer having the processor 110 as the central part thereof. The ROM 120 is a nonvolatile memory used exclusively to read data. The ROM 120 stores, for example, the firmware among the above-described programs. In addition, the ROM 120 also stores data and the like used when the processor 110 performs various kinds of processing.

The RAM 130 is a memory used to read and write data. The RAM 130 is used as a work area or the like that stores data used temporarily when the processor 110 performs various kinds of processing. The RAM 130 is typically a volatile memory.

The auxiliary storage unit 140 is an auxiliary storage unit of the computer having the processor 110 as the central part thereof. The auxiliary storage unit 140 is, for example, an electric erasable programmable read-only memory (EEPROM), a hard disk drive (HDD), a flash memory, or the like. The auxiliary storage unit 140 stores, for example, the system software and the application software among the above-described programs. In addition, the auxiliary storage unit 140 stores data used when the processor 110 performs various kinds of processing, data generated as a result of the processing by the processor 110, various kinds of set values, and the like.

The auxiliary storage unit 140 stores arrangement information and a size database (DB). The arrangement information includes information indicating the display sizes and arrangement of boxes on a display screen SC1. In addition, the arrangement information includes information indicating what kind of biological information is to be displayed in each box. Details of the display screen SC1 will be described later. The arrangement information may have initial values set in advance. The size DB is a database that stores and manages candidate information for each kind of biological information. The size DB, for example, stores candidate information in association with a biological information identification (ID). The biological information ID is identification information unique to each kind of biological information. Incidentally, even when pieces of biological information are the same kind, they are assigned different biological information IDs in a case where they are displayed numerically and a case where they are displayed in waveforms. The candidate information is information for identifying a display size candidate for a box which corresponds to the kind of the biological information identified by the associated biological information ID.

The touch panel 150 is, for example, a device formed by laminating a display such as a liquid crystal display or an organic electro-luminescence (EL) display and a pointing device used for touch input. The display is a display device that displays a screen for notifying an operator of the bedside monitor 100 or the like of various kinds of information. In addition, the pointing device is an input device that receives a touch operation made by the operator. It is to be noted that the display device and the input device included in the bedside monitor 100 are not limited to the example of the touch panel 150. The input device other than the touch panel 150 is, for example, a keyboard, a key pad, a touch pad, a mouse, a trackball, a joystick, a controller, or the like. Incidentally, a touch pad, a mouse, a trackball, and a joystick are examples of the pointing device. In addition, some of the controllers are examples of the pointing device. Incidentally, the “operator of the bedside monitor 100” will hereinafter be referred to simply as the “operator.” The operator is a medical worker, for example.

The communication interface 160 is an interface for the bedside monitor 100 to communicate with the measuring devices 200, a central monitor, a server, a portable terminal, and other external devices. The communication interface 160 is typically connected to the measuring devices 200 and the like by wire. That is, the bedside monitor 100 is connected to the measuring devices 200 and the like via the communication interface 160 and communication cables 300. The communication interface 160 includes female side connectors 161 for connection with the communication cables 300. The communication interface 160 has a function of detecting a disconnection of a communication cable 300 connected to a connector 161. Incidentally, the communication interface 160 may be connected to the measuring devices 200 and the like wirelessly. In addition, the communication interface 160 may communicate with the measuring devices 200 and the like via a server or the like.

The processor 110 acquires biological information from the measuring devices 200 via the communication cables 300. Hence, the processor 110 functions as an example of the “controller that acquires the biological information via a communication cable connected to the medical device.”

The bus 170 includes a control bus, an address bus, a data bus, and the like. The bus 170 transmits signals exchanged between various parts of the bedside monitor 100.

Each of the measuring devices 200 is a medical device that measures biological information of a subject such as a patient. The measuring device 200 is, for example, an electrocardiograph, a clinical thermometer, a sphygmomanometer, a pulse oximeter, or another medical measuring device. The measuring device 200 may be a device including a plurality of medical measuring devices. The clinical thermometer measures a body temperature. The sphygmomanometer measures a blood pressure. The electrocardiograph measures an electrocardiogram, a heart rate, and a respiration rate, for example. The pulse oximeter measures an oxygen saturation, a pulse rate, and a respiration rate, for example.

The communication cables 300 are cables that can transmit information by electricity, light, or the like. The communication cables 300 are wires or optical fibers, for example.

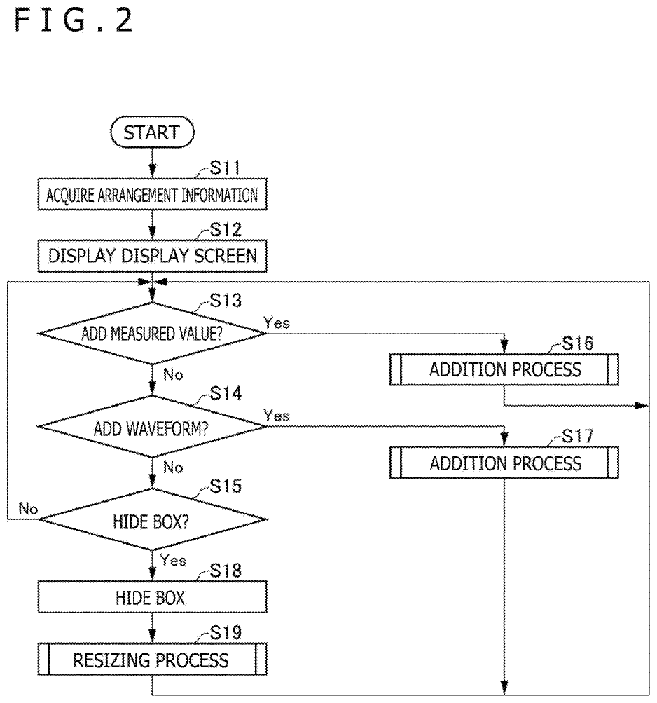

The operation of the display system 1 according to the embodiment will be described below on the basis of FIGS. 2 to 4 and the like. It is to be noted that the contents of a process described below in relation to the operation are given by way of example, and any of various processes capable of obtaining similar results can be used as appropriate. FIGS. 2 to 4 are flowcharts illustrating an example of a process of setting a display screen by the processor 110 of the bedside monitor 100. The processor 110 performs the process illustrated in FIGS. 2 to 4, for example, on the basis of a program stored in the ROM 120, the auxiliary storage unit 140, or the like. The processor 110 starts the process illustrated in FIG. 2 when the bedside monitor 100 is powered on, for example.

In step S11 in FIG. 2, the processor 110 of the bedside monitor 100 acquires arrangement information from the auxiliary storage unit 140. Incidentally, when the processor 110 fails to acquire arrangement information, the processor 110 creates new arrangement information, for example. Then, the processor 110 acquires the newly created arrangement information. The values of the newly created arrangement information are predetermined initial values, for example.

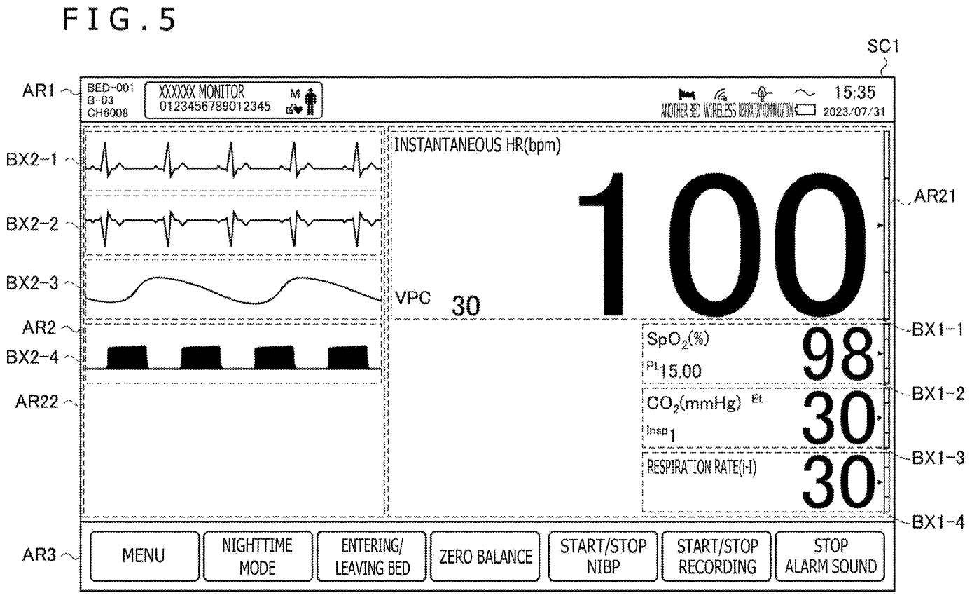

In step S12, the processor 110 generates an image corresponding to the display screen SC1 as illustrated in FIG. 5, on the basis of the arrangement information acquired in step S11. Then, the processor 110 instructs the touch panel 150 to display the generated image. Receiving the display instruction, the touch panel 150 displays the display screen SC1.

FIG. 5 is a diagram illustrating an example of the display screen SC1 displayed on the touch panel 150. The display screen SC1 is a screen for displaying biological information. The display screen SC1 includes areas AR1 to AR3 by way of example.

The area AR1 is an area that displays present date and time, various kinds of states of the bedside monitor 100, and the like.

The area AR2 is an area that displays boxes BX. The boxes BX are areas for displaying biological information. The boxes BX include, for example, two kinds of boxes, that is, measured value boxes BX1 and waveform boxes BX2 to be described later. The processor 110 displays the boxes BX at positions defined by the arrangement information. The boxes BX are areas that display information therein. The information typically includes biological information. The shape of the box is typically a quadrangular shape. The quadrangular shape may have rounded corners. Incidentally, the shape of the box BX may be other than the quadrangular shape. The shape of the box BX is preferably a horizontally long rectangular shape, for example, from the viewpoint of facilitating the viewing of measured values and waveforms of biological information displayed in the box BX. The processor 110 arranges one box BX or two or more boxes BX in such a manner that the boxes BX align to a grid within the area AR2 of the display screen SC1. In a case where the boxes BX have a quadrangular shape, for example, the grid is a rectangular grid. The grid represents guide positions for displaying the boxes BX. The boxes BX are automatically snapped into the grid. The vertical width of the quadrangular box BX is an integral multiple of the row height of the grid, for example. The vertical width of the quadrangular box BX may be half an integral multiple of the row height of the grid. The vertical width of the quadrangular box BX may be any other size. The horizontal width of the quadrangular box BX is an integral multiple of the column width of the grid, for example. The horizontal width of the quadrangular box BX may be half an integral multiple of the column width of the grid. The horizontal width of the quadrangular box BX may be any other size. The processor 110 may or may not display the outlines of the boxes BX. The area AR2 includes a measured value area AR21 (first area) and a waveform area AR22 (second area) by way of example.

The measured value area AR21 is an example of an area (first area) that displays measured values of biological information. The measured value area AR21 is an area for displaying the measured value boxes BX1. The measured value area AR21 is an area in which one or a plurality of measured value boxes BX1 can be arranged. Each of the measured value boxes BX1 is a box that displays a measured value of biological information. That is, the box BX1 is a box that displays biological information numerically. A grid for arranging the measured value boxes BX1 is set in advance in the measured value area AR21. The processor 110 arranges one or a plurality of measured value boxes BX1 in such a manner that the measured value boxes BX1 align to the grid. The measured value area AR21 includes one or a plurality of measured value boxes BX1 set for display. However, in a case where no measured value box BX1 is set for display, no measured value box BX1 may be displayed in the measured value area AR21. FIG. 5 illustrates four measured value boxes BX1, that is, measured value boxes BX1-1 to BX1-4, by way of example.

In addition, the measured value area AR21 also functions as a button. The button is operated by the operator to add and arrange a measured value box BX1 on the display screen SC1.

The waveform area AR22 is an example of an area (second area) that displays biological information in waveforms. The waveform area AR22 is an area for displaying the waveform boxes BX2. The waveform area AR22 is an area in which one or a plurality of waveform boxes BX2 can be arranged. Each of the waveform boxes BX2 is a box that displays biological information in a waveform. A grid for arranging the waveform boxes BX2 is set in advance in the waveform area AR22. The processor 110 arranges one or a plurality of waveform boxes BX2 in such a manner that the waveform boxes BX2 align to the grid. The waveform area AR22 includes one or a plurality of waveform boxes BX2 set for display. However, in a case where no waveform box BX2 is set for display, no waveform box BX2 may be displayed in the waveform area AR22. FIG. 5 illustrates four waveform boxes BX2, that is, waveform boxes BX2-1 to BX2-4, by way of example.

In addition, the waveform area AR22 also functions as a button. The button is operated by the operator to add and arrange a waveform box BX2 on the display screen SC1.

In the example of FIG. 5, a right portion of the area AR2 corresponds to the measured value area AR21. Moreover, a left portion of the area AR2 corresponds to the waveform area AR22. However, how to divide the area AR2 into the measured value area AR21 and the waveform area AR22 is not limited to the example of FIG. 5. Incidentally, broken lines indicating the measured value area AR21 and the waveform area AR22 in FIG. 5 are illustrated to indicate the ranges of the measured value area AR21 and the waveform area AR22. Hence, the broken lines may not be actually displayed.

The area AR3 is an area that displays various kinds of buttons including a menu button and the like.

The processor 110 functions as an example of the “controller that arranges a plurality of display areas displaying the biological information, side by side in a predetermined direction within the screen,” by arranging a plurality of boxes BX side by side in a predetermined direction (for example, a vertical direction) in such a manner that the boxes BX align to the grid on the display screen SC1. Incidentally, the vertical direction in FIG. 5 is an upward-downward direction when the area AR1 is assumed to be on an upper side and the area AR3 is assumed to be on a lower side.

When the operator intends to add a measured value box BX1, the operator performs an operation of giving an instruction to add the measured value box BX1 (third input). The operation is a predetermined operation such as a tap operation on the measured value area AR21, for example.

In step S13, the processor 110 determines whether or not the operation of giving an instruction to add a measured value box BX1 is performed. When the operator does not perform the operation of giving an instruction to add a measured value box BX1, the processor 110 determines No in step S13 and then proceeds to step S14.

When the operator intends to add a waveform box BX2, the operator performs an operation of giving an instruction to add the waveform box BX2 (fourth input). The operation is a predetermined operation such as a tap operation on the waveform area AR22, for example.

In step S14, the processor 110 determines whether or not the operation of giving an instruction to add a waveform box BX2 is performed. When the operation of giving an instruction to add a waveform box BX2 is not performed, the processor 110 determines No in step S14 and then proceeds to step S15.

In step S15, the processor 110 determines whether or not to hide any one of the boxes BX displayed in the area AR2. For example, when it is detected that a communication cable 300 connected to a measuring device 200 measuring certain biological information is disconnected from a connector 161, and when a box BX displaying the biological information acquired via the relevant communication cable 300 is being displayed, the processor 110 determines that the relevant box BX is to be hidden. When determining that none of the boxes BX is to be hidden, the processor 110 determines No in step S15. The processor 110 then returns to step S13. Thus, the processor 110 enters a standby state in which the processor 110 repeats steps S13 to S15 until the operation of giving an instruction to add a measured value box BX1 or the operation of giving an instruction to add a waveform box BX2 is performed or the processor 110 determines that any one of the boxes BX displayed in the area AR2 is to be hidden.

When the operation of giving an instruction to add a measured value box BX1 (step S13) or the operation of giving an instruction to add a waveform box BX2 (step S14) is performed while the processor 110 is in the standby state in which the processor 110 repeats steps S13 to S15 illustrated in FIG. 2, the processor 110 determines Yes in step S13 or step S14 and then proceeds to step S16 or step S17.

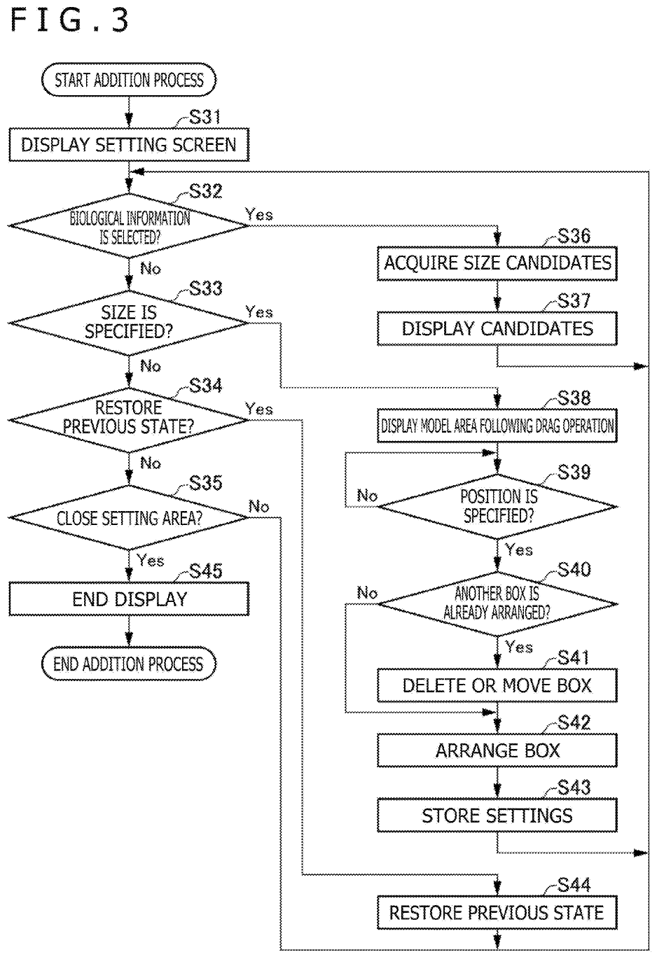

In step S16 or step S17 illustrated in FIG. 2, the processor 110 performs an addition process illustrated in FIG. 3. The addition process illustrated in FIG. 3 is a process for adding and arranging a box BX for displaying biological information on the display screen SC1. The addition process includes two kinds of processes, that is, a numerical value addition process (step S16) and a waveform addition process (step S17). The numerical value addition process (step S16) is a process for adding and arranging a measured value box BX1 for displaying a measured value of biological information on the display screen SC1. The waveform addition process (step S17) is a process for adding and arranging a waveform box BX2 for displaying a waveform of biological information on the display screen SC1. A detailed description of the addition process will be made later.

When the operation of giving an instruction to add a measured value box BX1 is performed while the processor 110 is in the standby state in which the processor 110 repeats steps S13 to S15 illustrated in FIG. 2, the processor 110 determines Yes in step S13 and then proceeds to step S16. The processor 110 performs the numerical value addition process illustrated in FIG. 3 in step S16.

When the operation of giving an instruction to add a waveform box BX2 is performed while the processor 110 is in the standby state in which the processor 110 repeats steps S13 to S15 illustrated in FIG. 2, on the other hand, the processor 110 determines Yes in step S14 and then proceeds to step S17. The processor 110 performs the waveform addition process illustrated in FIG. 3 in step S17.

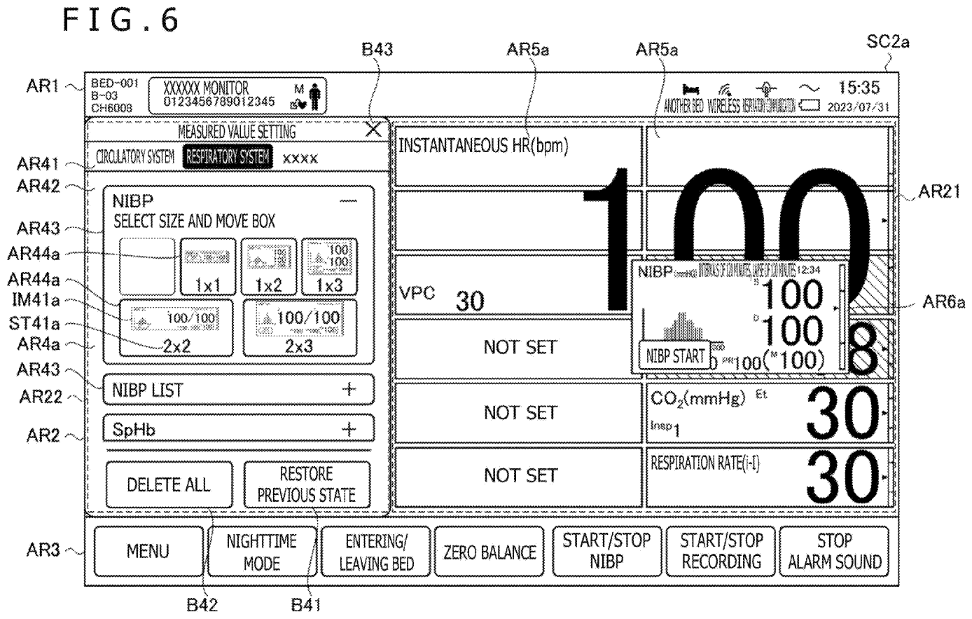

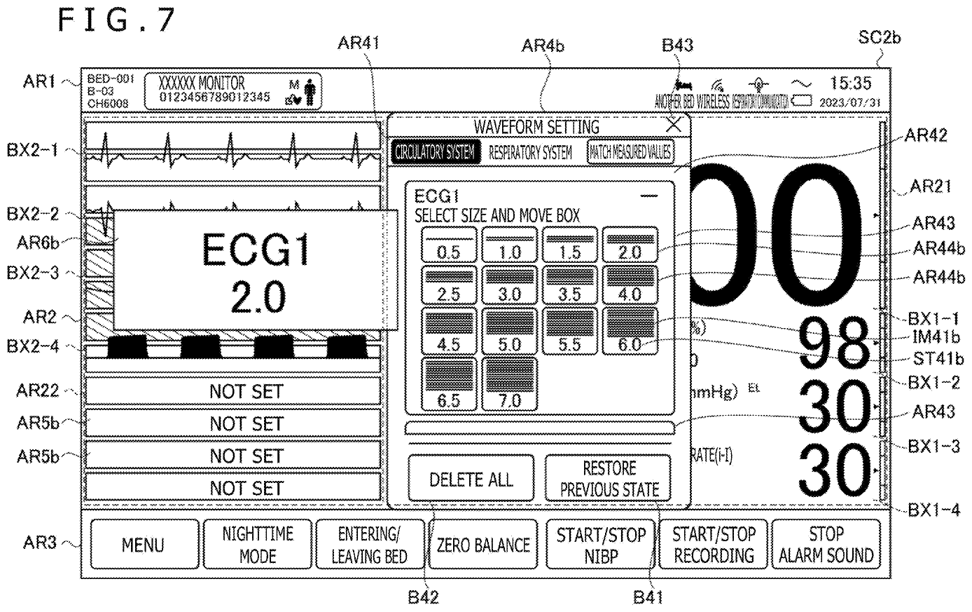

Details of the addition process in FIG. 3 will next be described. In step S31 in FIG. 3, the processor 110 generates an image corresponding to a setting screen SC2a as illustrated in FIG. 6 or a setting screen SC2b as illustrated in FIG. 7. Incidentally, the setting screen SC2a and the setting screen SC2b will hereinafter be referred to collectively as a “setting screen SC2.” Then, the processor 110 instructs the touch panel 150 to display the generated image. Receiving the display instruction, the touch panel 150 displays the setting screen SC2. The processor 110 displays the setting screen SC2a in the numerical value addition process (step S16). The processor 110 displays the setting screen SC2b in the waveform addition process (step S17).

FIG. 6 is a diagram illustrating an example of the setting screen SC2a displayed on the touch panel 150. FIG. 7 is a diagram illustrating an example of the setting screen SC2b displayed on the touch panel 150. The setting screen SC2a is a screen that displays a setting area AR4a within the display screen SC1. The setting screen SC2b is a screen that displays a setting area AR4b within the display screen SC1. Incidentally, the setting area AR4a and the setting area AR4b will hereinafter be referred to collectively as a “setting area AR4.” Hence, the setting screen SC2 is a screen that displays the setting area AR4 within the display screen SC1. The setting screen SC2 is a screen for selecting biological information to be newly arranged and setting the display size and display position of the biological information. The operator makes the selection and the setting by operating the setting screen SC2. The setting screen SC2a illustrated in FIG. 6 and the setting screen SC2b illustrated in FIG. 7 include, for example, the setting area AR4 and areas AR5 in addition to the areas AR1 to AR3 described above. Incidentally, the area AR5 is a collective term for an area AR5a and an area AR5b. The setting screen SC2a illustrated in FIG. 6 includes the areas AR5a as the areas AR5. The setting screen SC2b illustrated in FIG. 7 includes the areas AR5b as the areas AR5.

The setting area AR4 (the setting area AR4a illustrated in FIG. 6 and the setting area AR4b illustrated in FIG. 7) is an area (third area) for selecting biological information to be newly arranged. The operator makes the selection by operating the setting area AR4.

As illustrated in FIG. 6, in a case where a measured value of biological information to be newly arranged is added, the processor 110 displays the setting area AR4a in a state of being superposed on the waveform area AR22 or within the waveform area AR22, for example. The processor 110 displays the setting area AR4a such that the setting area AR4a does not extend off the waveform area AR22 and is included within the waveform area AR22. Alternatively, the processor 110 displays the setting area AR4a such that the setting area AR4a at least partly overlaps the waveform area AR22.

As illustrated in FIG. 7, in a case where a waveform of biological information to be newly arranged is added, the processor 110 displays the setting area AR4b in a state of being superposed on the measured value area AR21 or within the measured value area AR21. The processor 110 displays the setting area AR4b such that the setting area AR4b does not extend off the measured value area AR21 and is included within the measured value area AR21. Alternatively, the processor 110 displays the setting area AR4b such that the setting area AR4b at least partly overlaps the measured value area AR21.

The processor 110 may display the setting area AR4 in a state of being overlaid on the area AR2. The setting area AR4 includes, for example, an area AR41, an area AR42, a restore button B41, a delete button B42, and a close button B43.

The area AR41 is an area for selecting a classification of biological information. FIG. 6 and FIG. 7 each illustrate a “circulatory system” and a “respiratory system” as such classifications. The operator can select a classification by operating the area AR41. For example, the “respiratory system” is selected in the area AR41 in FIG. 6, and the “circulatory system” is selected in the area AR41 in FIG. 7.

The area AR42 is an area for selecting biological information. The area AR42 includes one or a plurality of areas AR43. Each area AR43 corresponds to biological information pertinent to the classification selected in the area AR41. The operator can select an area AR43 by operating the area AR43. When an area AR43 is selected, biological information corresponding to the area AR43 being selected is accordingly selected. Hence, by operating an area AR43, the operator can select biological information corresponding to the relevant area AR43. For example, an area AR43 of “NIBP (blood pressure)” is selected in the area AR42 in FIG. 6, and an area AR43 of “ECG1 (electrocardiogram)” is selected in the area AR42 in FIG. 7.

The area AR43 being selected includes one or a plurality of areas AR44. Each area AR44 indicates a display size candidate for a box BX. The box BX is a box that displays biological information corresponding to the selected area AR43. Incidentally, FIG. 6 illustrates the areas AR44 in the setting area AR4a as areas AR44a. In addition, FIG. 7 illustrates the areas AR44 in the setting area AR4b as areas AR44b.

A plurality of areas AR44a illustrated in FIG. 6 indicate a plurality of display size candidates for a measured value box BX1 with regard to the same biological information. The plurality of areas AR44a correspond to different display sizes. Each of the areas AR44a includes, for example, a model image IM41a and a character string ST41a.

The model image IM41a is an image indicating a display size of a measured value box BX1 for displaying a measured value of the biological information being selected. Incidentally, the image is a collective term for a still image and a moving image. The model image IM41a is a reduced-size image of a measured value box BX1 for displaying biological information being selected. In addition, the model image IM41a is a reduced-size image of a measured value box BX1 of a display size corresponding to the area AR44a. Contents similar to display contents of the relevant measured value box BX1 are displayed within the area AR44a. Incidentally, a reduction ratio of the reduced-size image is the same in each area AR44a. Because the model image IM41a is a reduced-size image of a measured value box BX1, the aspect ratio of the model image IM41a and the aspect ratio of the relevant measured value box BX1 coincide with each other. The processor 110 displays and updates a numerical value in the model image IM41a (measured value of biological information being measured by the measuring device 200) in real time. The processor 110 updates the measured value in real time by, for example, updating the display of the measured value in the model image IM41a to a new numerical value each time the new measured value is acquired. Alternatively, the processor 110 may not update the measured value in the model image IM41a in real time but use a fixed value such as a value measured in the past or a predetermined value. In addition, the processor 110 may also display information other than the numerical value in the model image IM41a in real time. For example, as a real-time display of information other than the numerical value, the processor 110 may have a display change at a time of an alarm operation reflected.

The character string ST41a indicates a display size of a measured value box BX1 as a character string. The character string ST41a illustrated in FIG. 6 indicates the display size in a format of “(horizontal width)×(vertical width).” Here, the vertical width in the character string ST41a represents a multiple of the vertical width of a numerical value cell. In addition, the horizontal width in the character string ST41a represents a multiple of the horizontal width of a numerical value cell. A numerical value cell refers to one cell of a grid which divides the measured value area AR21 in a lattice manner. Hence, the unit of the vertical width and the horizontal width is a cell. One cell is referred to also as a grid cell. The processor 110 arranges boxes BX in such a manner that the boxes BX align to cells of the grid. However, in a case where the vertical width of a box BX is not an integer, the processor 110 arranges the box BX such that the upper side of the box BX coincides with the upper side of a cell, for example. Alternatively, the processor 110 arranges the box BX such that the lower side of the box BX coincides with the lower side of a cell. That is, the processor 110 snaps the upper side or lower side of the box BX into the grid. In addition, in a case where the horizontal width of a box BX is not an integer, the processor 110 arranges the box BX such that the right side of the box BX coincides with the right side of a cell, for example. Alternatively, the processor 110 arranges the box BX such that the left side of the box BX coincides with the left side of a cell. That is, the processor 110 snaps the left side or the right side of the box BX into the grid.

A plurality of areas AR44b illustrated in FIG. 7 indicate a plurality of display size candidates for a waveform box BX2 with regard to the same biological information. The plurality of areas AR44b correspond to different display sizes. Each of the areas AR44b includes, for example, a model image IM41b and a character string ST41b.

The model image IM41b is an image indicating a display size of a waveform box BX2. The size of the model image IM41b corresponds to a display size corresponding to the area AR44b, for example. The model image IM41b illustrated in FIG. 7 includes, for example, horizontal bars which are arranged vertically and the number of which corresponds to twice the vertical width of the waveform box BX2. In this manner, the model image IM41b represents the vertical width of the display size of the waveform box BX2 by the number of the horizontal bars.

The character string ST41b indicates a display size of a waveform box BX2 as a character string. The character string ST41b illustrated in FIG. 7 indicates the display size by using a numerical value of “(vertical width).” Here, the vertical width in the character string ST41b represents a multiple of the vertical width of a waveform cell. A waveform cell refers to one cell of a grid which divides the waveform area AR22 in a lattice manner. Incidentally, the character string ST41b does not indicate the horizontal width of a waveform box BX2. This is because the horizontal width of a waveform box is fixed at the value corresponding to one waveform cell. In a case where the horizontal width of a waveform box BX2 is not fixed at the value corresponding to one waveform cell, the character string ST41b of the waveform box BX2 may indicate the display size of the waveform box BX2 in a format of “(horizontal width)×(vertical width),” as in the character string ST41a of the measured value box BX1.

Each area AR5 represents one cell of the grid which divides the area AR2 in a lattice manner. FIG. 6 illustrates the areas AR5 within the measured value area AR21 as the areas AR5a. FIG. 7 illustrates the areas AR5 within the waveform area AR22 as the areas AR5b.

Each area AR5a represents a numerical value cell. In FIG. 6, the grid divides the measured value area AR21 into six cells in a vertical direction and two cells in a horizontal direction. Hence, the measured value area AR21 illustrated in FIG. 6 has the areas AR5 a of 12 cells.

Each area AR5b represents a waveform sub-cell. The waveform sub-cell is obtained by dividing a waveform cell into two portions in the upward-downward direction. Hence, the vertical width of the waveform sub-cell is half that of the waveform cell. The horizontal width of the waveform sub-cell is equal to that of the waveform cell. In FIG. 7, the grid divides the waveform area AR22 into six cells in the vertical direction and one cell in the horizontal direction. The number of waveform sub-cells is twice that of waveform cells. The waveform area AR22 illustrated in FIG. 7 therefore has 12 areas AR5b.

The restore button B41 is a button operated by the operator to instruct the bedside monitor 100 to restore the arrangement of the boxes BX to a previous state. Restoring the previous state is referred to also as undoing.

The delete button B42 is a button operated by the operator to delete all the boxes BX arranged in the area AR2. When the delete button B42 is operated, the processor 110 deletes all the boxes BX arranged in the area AR2. When the delete button B42 in the setting area AR4a is operated, the processor 110 may delete all the boxes BX arranged in the measured value area AR21. When the delete button B42 in the setting area AR4b is operated, the processor 110 may delete all the boxes BX arranged in the waveform area AR22.

The close button B43 is a button operated by the operator to instruct the bedside monitor 100 to close the setting area AR4. In other words, the close button B43 is a button operated by the operator to instruct the bedside monitor 100 to make a transition from the setting screen SC2 to the display screen SC1.

Incidentally, the measured value area AR21 described above is an example of the “first area that displays a measured value of biological information,” and the waveform area AR22 is an example of the “second area that displays a waveform of biological information.”

In addition, the setting area AR4a is an example of the “third area including the plurality of display size candidates corresponding to the measured value of the biological information specified by first input.” Moreover, the operation of giving an instruction to add a measured value box BX1 is an example of the “third input that specifies a measured value as biological information to be displayed on the screen.” Hence, the processor 110 functions as an example of the “controller that displays the third area in a state of being superposed on the second area, in response to the third input,” by performing the processing of step S13 in FIG. 2 and the processing of step S31 in FIG. 3 in the numerical value addition process.

In addition, the setting area AR4b is an example of a “fourth area including the plurality of display size candidates corresponding to the waveform of the biological information specified by the first input.” Moreover, the operation of giving an instruction to add a waveform box BX2 is an example of the “fourth input that specifies a waveform as biological information to be displayed on the screen.” Hence, the processor 110 functions as an example of the “controller that displays the fourth area in a state of being superposed on the first area, in response to the fourth input,” by performing the processing of step S14 in FIG. 2 and the processing of step S31 in FIG. 3 in the waveform addition process.

In addition, each of the model image IM41a and the model image IM41b is an example of a “first display area model.” Hence, the processor 110 functions as an example of the “controller that displays a plurality of display area models corresponding to a plurality of display sizes, as the plurality of display size candidates on the screen,” by displaying a plurality of areas AR44 in the processing of step S31.

In addition, the model image IM41a is an example of a “display model including a real-time display of the biological information specified by the first input.”

The detailed description has been thus far made of the setting screen SC2 displayed by the setting screen display processing (step S31) in the addition process of FIG. 3. Next, processing of step S32 and subsequent processing in the addition process of FIG. 3 will be described.

In step S32, the processor 110 determines whether or not an operation of selecting biological information (first input) is performed by the operator. The operator performs the operation of selecting biological information by, for example, selecting a classification of the biological information in the area AR41 and then operating the area AR42. When the processor 110 does not determine that the operation of selecting biological information is performed, the processor 110 determines No in step S32 and then proceeds to step S33.

In step S33, the processor 110 determines whether or not an operation of specifying a size of a box BX to be newly arranged (second input) is performed. When the processor 110 does not determine that the operation of specifying a size of a box to be newly arranged is performed, the processor 110 determines No in step S33 and then proceeds to step S34.

In step S34, the processor 110 determines whether or not the restore button B41 is operated. When the restore button B41 is not operated, the processor 110 determines No in step S34 and then proceeds to step S35.

In step S35, the processor 110 determines whether or not to close the setting area AR4. The processor 110 determines that the setting area AR4 is to be closed, when the close button B43 is operated, for example. In addition, the processor 110 may determine that the setting area AR4 is to be closed, also when a predetermined period of time has passed without any operation being performed. When the processor 110 does not determine that the setting area AR4 is to be closed, the processor 110 determines No in step S35 and returns to step S32. Thus, the processor 110 enters a standby state in which the processor 110 repeats steps S32 to S35 until the processor 110 determines that the operation of selecting biological information is performed, the processor 110 determines that the operation of specifying a size of a box BX to be newly arranged is performed, the restore button B41 is operated, or the processor 110 determines that the setting area AR4 is to be closed.

When the operation of selecting biological information is performed while the processor 110 is in the standby state in which the processor 110 repeats steps S32 to S35, the processor 110 determines Yes in step S32 and then proceeds to step S36.

The operation of selecting biological information is an example of the “first input that specifies biological information to be displayed on the screen.” Hence, the processor 110 functions as an example of the “controller that receives the first input,” by performing the processing of step S32.

In step S36, the processor 110 refers to the size DB and acquires candidate information associated with a biological information ID of the selected biological information.

In step S37, on the basis of the candidate information acquired in step S36, the processor 110 displays display size candidates corresponding to the biological information selected in step S32, within the area AR43 of the selected biological information. That is, the processor 110 displays, within the area AR43, one or a plurality of areas AR44 each corresponding to a respective one of the display size candidates which are indicated by the candidate information. Incidentally, in a case where, at a time point when the operation of selecting biological information is performed, other biological information has already been selected, the processor 110 cancels the selection of the other biological information, so that the other biological information is now not selected. The processor 110 hides all areas AR44 within an area AR43 corresponding to the biological information whose selection is canceled. The processor 110 returns to step S32 after the processing of step S37.

Thus, by performing the processing of step S37, the processor 110 functions as an example of the “controller that displays, on the screen, a plurality of display size candidates corresponding to the biological information specified by the first input.”

When the operator intends to arrange a new box BX for displaying the biological information selected in step S32, the operator performs a first operation and a second operation by using the input device. The first operation is an operation of specifying a display size of the box. The second operation is an operation of specifying a position at which to arrange the box BX.

For example, drag and drop includes the first operation and the second operation. The first operation is, for example, a press operation in the drag and drop. In an operation using the touch panel 150, the press operation is an operation of touching the touch panel 150 with a finger, a touch pen, or the like. In an operation using a mouse, the press operation is an operation of depressing a mouse button. The operation of depressing a mouse button is referred to also as a mouse down. The mouse button is typically a left button, but is not limited to this. A starting point of the drag and drop is a position at which the first operation is performed.

The second operation is a drop operation in the drag and drop. In an operation using the touch panel 150, the drop operation is an operation of moving a finger, a touch pen, or the like away from the touch panel 150. In an operation using a mouse, the drop operation is an operation of releasing the depression of a mouse button. The operation of releasing the depression of a mouse button is referred to also as a mouse up. An end point of the drag and drop is a position at which the second operation is performed.

The operator performs the first operation on an area AR44 corresponding to a desired display size displayed on the setting screen SC2 illustrated in FIG. 6 or FIG. 7. The processor 110 regards the display size corresponding to the relevant area AR44, as a specified size. The specified size is a display size specified by the first operation.

When the first operation is performed, the processor 110 determines that the operation of specifying a size of a box BX to be newly arranged is performed. When the processor 110 determines that the operation of specifying a size of a box BX to be newly arranged is performed while the processor 110 is in the standby state in which the processor 110 repeats steps S32 to S35, the processor 110 determines Yes in step S33 and then proceeds to step S38.

The first operation is an example of the “second input that specifies one display size from the plurality of display size candidates.” Hence, the processor 110 functions as an example of the “controller that receives the second input,” by performing the processing of step S33. In addition, the first operation is an example of “input that specifies the display size by using a starting point of a drag operation.”

After the first operation, the operator performs a drag operation to a position at which the operator intends to arrange the box BX.

In step S38, the processor 110 displays a model area AR6 on the setting screen SC2. Then, the processor 110 causes the model area AR6 to follow a drag operation made by the operator. For example, the processor 110 moves the model area AR6 on the setting screen SC2 according to the drag operation. Incidentally, FIG. 6 illustrates a model area AR6a as the model area AR6. FIG. 7 illustrates a model area AR6b as the model area AR6.

The model area AR6a displays a full-size image or a reduced-size image of a measured value box BX1 corresponding to the display size specified in step S33 (that is, the specified size) from the display size candidates for the biological information selected in step S32. Incidentally, the model area AR6a displays a full-size image or a reduced-size image of a measured value box BX1 of the specified size. Contents similar to display contents of the relevant measured value box BX1 are displayed within the model area AR6a. Because the model area AR6a displays a full-size image or a reduced-size image of a numerical value box BX1, the aspect ratio of the model area AR6a and the aspect ratio of the numerical value box BX1 coincide with each other. The processor 110 displays the measured value in the model area AR6a in real time. That is, the processor 110 updates the measured value in the model area AR6a in real time. Alternatively, the processor 110 may not update the measured value in the model area AR6a in real time but use a fixed value such as a value measured in the past or a predetermined value. In addition, the processor 110 may also display information other than the numerical value in the model area AR6a in real time. For example, as a real-time display of information other than the numerical value, the processor 110 may have a display change at a time of an alarm operation reflected.

The model area AR6b displays a full-size image or a reduced-size image of a waveform box for displaying the biological information being selected. Incidentally, the model area AR6b represents the external shape of the waveform box. That is, a waveform or the like is not displayed within the model area AR6b. The aspect ratio of the model area AR6b is the same as that of the display size selected by the first operation.

In addition, in order to indicate in which areas AR5 a box BX is to be arranged when the second operation is performed at a present position, the processor 110 changes the external appearance of some of the areas AR5 where the relevant box BX is to be arranged. The processor 110 changes the external appearance of some of the areas AR5 where the box BX is to be arranged, by, for example, subjecting the relevant areas to display change processing such as a color change (see FIG. 6 and FIG. 7), blinking, or edging.

After the drag operation, the operator performs the second operation at a position at which the operator intends to arrange the box BX. The position is within the measured value area AR21 in the numerical value addition process. The position is within the waveform area AR22 in the waveform addition process. The processor 110 regards the position as a specified position. The specified position is an arrangement position specified by the second operation.

The model area AR6 is an example of a second display area model. Hence, the processor 110 functions as an example of the “controller that displays a second display area model corresponding to the display size specified by the drag operation, in such a manner that the second display area model follows the drag operation, the second display area model including a real-time display of the biological information specified by the first input,” by performing the processing of step S38.

In step S39, the processor 110 waits for the specification of an arrangement position of the box BX. The processor 110 determines that the arrangement position of the box BX is specified, in response to the execution of the second operation, for example. When the processor 110 determines that the arrangement position of the box BX is specified, the processor 110 determines Yes in step S39 and then proceeds to step S40.

In step S40, the processor 110 determines whether or not another box BX is already arranged at the specified position. When another box BX is already arranged at the specified position, the processor 110 determines Yes in step S40 and then proceeds to step S41.

In step S41, the processor 110 performs any one of the following processing (A1) to processing (A3) on the box BX already arranged at the specified position. The processor 110 decides which processing to perform, according to a setting, for example. For example, an administrator or a designer of the display system 1 decides the contents of the setting in advance.

### (A1) Deletion Processing

The processor 110 deletes the box BX already arranged at the specified position. That is, the processor 110 hides the relevant box.

### (A2) Movement Processing

The processor 110 moves the box BX already arranged at the specified position to a position that is different from the specified position of the box BX to be newly arranged. That is, the processor 110 changes the position of the box BX already arranged at the specified position. At this time, the processor 110 may move, in addition to the box BX already arranged at the specified position, a plurality of boxes BX including other boxes BX already arranged at positions other than the specified position.

### (A3) Display Size Change Processing

The processor 110 changes the display size of the box BX already arranged at the specified position. At this time, the processor 110 changes the display size of the box BX such that a display range of the box BX does not include the specified position.

Thus, the processor 110 functions as an example of the “controller that, when, at a position where a display area is to be arranged, another display area is already arranged, deletes or moves the other display area or changes a display size thereof,” by performing the processing of step S41.

When no box BX is already arranged at the specified position, the processor 110 determines No in step S40 and then proceeds to step S42. In addition, the processor 110 proceeds to step S42 after the processing of step S41.

In step S42, the processor 110 arranges the box BX of the specified size at the specified position. This box BX is a box that displays the biological information selected in step S32. In the numerical value addition process, this box is a measured value box BX1. In the waveform addition process, this box is a waveform box BX2.

In step S42, the processor 110 arranges the box BX of the specified size in such a manner that the box BX aligns to the grid at the specified position. Hence, the processor 110 functions as an example of the “controller that arranges, on the screen, a display area of the display size specified by the second input, in such a manner that the display area aligns to a grid set in advance,” by performing the processing of step S42.

In addition, the processor 110 functions as an example of the “controller that displays the biological information specified by the first input within the display area,” by performing the processing of step S42. Moreover, the processor 110 functions as an example of the “controller that arranges the display area of the display size specified by the drag operation, at an end point of the drag operation,” by performing the processing of step S39 and step S42.

In step S43, the processor 110 updates the arrangement information to reflect therein the change of the arrangement of the box BX on the display screen SC1. That is, the processor 110 updates the arrangement information to reflect therein the addition of the box BX made by the processing of step S42. In addition, in a case where the processor 110 has performed the processing of step S41, the processor 110 updates the arrangement information to reflect therein the arrangement changed by the processing (A1) to (A3). Incidentally, the processor 110 also stores the arrangement information that is yet to be updated. The processor 110 returns to step S32 after the processing of step S43.

When the restore button B41 is operated while the processor 110 is in the standby state in which the processor 110 repeats steps S32 to S35, the processor 110 determines Yes in step S34 and then proceeds to step S44.

In step S44, the processor 110 restores (undoes) the addition of the new box BX performed last to a previous state. That is, in a case where the processor 110 has determined Yes in the processing of step S40 performed last, the processor 110 cancels the processing of steps S41 to S43 performed last and restores the previous state in which the above processing has not been performed. In a case where the processor 110 has determined No in the processing of step S40, the processor 110 cancels the processing of steps S41 and S42 performed last and restores the previous state in which the above processing has not been performed. The processor 110 undoes the processing by, for example, using the arrangement information that is yet to be updated. The processor 110 returns to step S32 after the processing of step S44.

When the processor 110 determines that the setting area AR4 is to be closed while the processor 110 is in the standby state in which the processor 110 repeats steps S32 to S35, the processor 110 determines Yes in step S35 and then proceeds to step S45.

In step S45, the processor 110 closes the setting area AR4. The processor 110 thereby causes the display on the touch panel 150 to make a transition from the setting screen SC2 to the display screen SC1.

The processor 110 ends the addition process illustrated in FIG. 3 after the processing of step S45. The processor 110 ends the processing of step S16 in FIG. 2 with an end of the numerical value addition process. The processor 110 returns to step S13 after the processing of step S16. The processor 110 ends the processing of step S17 with an end of the waveform addition process. The processor 110 returns to step S13 after the processing of step S17.

Thus, the processor 110 functions as an example of the “controller that arranges the display area in the first area when the biological information specified by the first input is a measured value, and arranges the display area in the second area when the biological information specified by the first input is a waveform,” by performing the processing of step S13, step S14, step S16, and step S17 illustrated in FIG. 2.

When the processor 110 determines that any one of the boxes BX displayed in the area AR2 is to be hidden while the processor 110 is in the standby state in which the processor 110 repeats steps S13 to S15, the processor 110 determines Yes in step S15 and then proceeds to step S18.

In step S18, the processor 110 hides the box BX determined to be hidden.

Thus, the processor 110 functions as an example of the “controller that hides a display area for which the biological information is not able to be acquired among the plurality of display areas,” by performing the processing of step S15 and step S18 illustrated in FIG. 2. The processor 110 functions as an example of the “controller that hides the display area for which the biological information is not able to be acquired due to a disconnection of the communication cable from the medical device,” by performing the processing of step S15 and step S18.

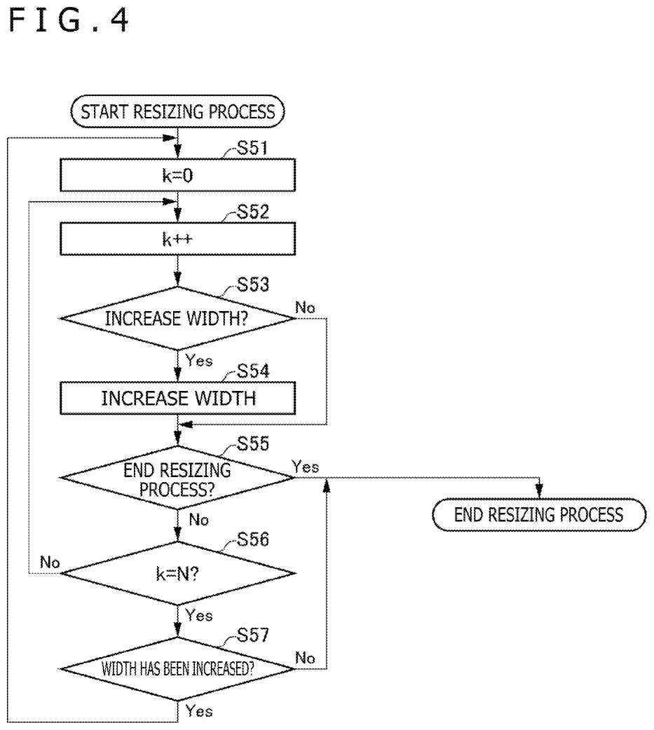

In step S19, the processor 110 perform a resizing process illustrated in FIG. 4. The resizing process is a process for filling a blank by changing a display size of at least one of other boxes BX arranged in the same column as the box BX hidden in step S18. Here, the blank refers to a space in which no box BX is displayed within the area AR2. In addition, a column refers to a sequence in the vertical direction. Incidentally, in a case where a box BX displayed across a plurality of columns is hidden in step S18, the processor 110 performs the resizing process in order for each of the plurality of columns.

In step S51 in FIG. 4, the processor 110 of the bedside monitor 100 initializes the value of a variable k. That is, the processor 110 sets the value of the variable k to zero.

In step S52, the processor 110 increments the value of the variable k by one.

In step S53, the processor 110 determines whether or not the width of a k-th box BX (hereinafter referred to as a “k-th box BX-k”) is to be increased. When the vertical width of the k-th box BX-k can be increased by one cell, the processor 110 determines that the width of the k-th box BX-k is to be increased. Incidentally, the k-th box BX-k is a box BX which is one of the other boxes BX displayed in the same column as the box BX hidden in step S18 and which is the k-th box BX from one end. Incidentally, the one end refers to either of the opposite ends of the column. The box BX at the one end is a box BX closest to the one end. Hence, the box BX at the one end is an uppermost or lowermost box BX in the column. The box BX at the one end corresponds to a first box BX-1.

The processor 110 determines that the vertical width of the k-th box BX-k can be increased by one, when at least one of the following conditions of (B1) and (B2) is satisfied.

(B1) There is a blank of one cell or more at a position preceding the k-th box BX in all the columns in which the k-th box BX-k is displayed.

(B2) There is a blank of one cell or more at a position succeeding the k-th box BX in all the columns in which the k-th box BX-k is displayed.

Incidentally, the position preceding the k-th box BX-k is a position on a side closer to the one end than the k-th box BX-k. The position succeeding the k-th box BX-k is a position on a side farther from the one end than the k-th box BX-k.

When the processor 110 is to increase the width of the k-th box BX-k, the processor 110 determines Yes in step S53 and then proceeds to step S54.

In step S54, the processor 110 increases the vertical width of the k-th box BX-k by one cell. At this time, when the condition of (B1) is satisfied, the processor 110 increases the vertical width of the k-th box BX-k to the one end side. However, in a case where another box BX is present at a position preceding the k-th box BX-k and is adjacent to the k-th box BX-k, the processor 110 moves a box BX or boxes BX present between the other box BX and the blank to the one end side by one cell and then increases the vertical width of the k-th box BX-k. Incidentally, there may be a plurality of blanks preceding the k-th box BX-k. In this case, for example, the processor 110 moves, to the one end side by one cell, a box BX or boxes BX present between the k-th box BX-k and a blank closest to the k-th box BX-k among the blanks present at positions preceding the k-th box BX-k. The processor 110 performs this movement for all the columns in which the k-th box BX-k is displayed.

When the condition of (B2) is satisfied, the processor 110 increases the vertical width of the k-th box BX-k to an opposite end side which is opposite to the one end side. However, in a case where a box BX is present at a position succeeding the k-th box BX-k and is adjacent to the k-th box BX-k, the processor 110 moves a box BX or boxes BX present between the relevant box BX and the blank to the opposite end side by one cell and then increases the vertical width of the k-th box BX-k. Incidentally, there may be a plurality of blanks succeeding the k-th box BX-k. In this case, for example, the processor 110 moves, to the opposite end side by one cell, a box BX or boxes BX present between the k-th box BX-k and a blank closest to the k-th box BX-k among the blanks present at positions succeeding the k-th box BX-k. The processor 110 performs this movement for all the columns in which the k-th box BX-k is displayed.

Incidentally, when the conditions of both (B1) and (B2) are satisfied, the processor 110 increases the vertical width of the k-th box BX-k to either the one end side or the opposite end side. The designer or the administrator of the display system 1, for example, decides in advance which of the one end side and the opposite end side is prioritized.

When the processor 110 does not increase the width of the k-th box BX-k, the processor 110 determines No in step S53 and then proceeds to step S55. In addition, the processor 110 proceeds to step S55 after the processing of step S54.

In step S55, the processor 110 determines whether or not to end the resizing process. The processor 110 determines whether or not to end the resizing process, according to a determination of either (C1) or (C2) described below, for example.

(C1) The processor 110 determines that the resizing process is to be ended, when there is no blank in the same column as the box BX hidden in step S18.

(C2) The processor 110 determines that the resizing process is to be ended, when a total width increased by the resizing process is equal to the vertical width of the box BX hidden in step S18.

The administrator or the designer of the display system 1, for example, decides in advance which of the determinations of (C1) and (C2) to use. When the processor 110 determines that the resizing process is to be ended, the processor 110 determines Yes in step S55 and ends the resizing process illustrated in FIG. 4. When the processor 110 does not determine that the resizing process is to be ended, on the other hand, the processor 110 determines No in step S55 and then proceeds to step S56.

In step S56, the processor 110 determines whether or not the value of the variable k is equal to the number N of the boxes BX displayed in the same column as the box BX hidden in step S18. When the value of the variable k is not equal to N, the processor 110 determines No in step S56 and returns to step S52. Thus, by repeating steps S52 to S56, the processor 110 performs the processing of steps S53 to S56 while incrementing k by one from k=1 to k=N. The processor 110 thereby performs the processing of step S53 and step S54 in order from a first box B1 to an N-th box BXN.

When the value of the variable k is equal to N, the processor 110 determines Yes in step S56 and then proceeds to step S57.

In step S57, the processor 110 determines whether or not the width of any one of the boxes BX has been increased since the last initialization of the value of the variable k. When the width of any one of the boxes BX has been increased, the processor 110 determines Yes in step S57 and returns to step S51. When none of the boxes BX has been increased in width since the last initialization of the value of the variable k, on the other hand, the processor 110 determines No in step S57 and then ends the resizing process illustrated in FIG. 4.

The processor 110 ends the processing of step S19 in FIG. 2 with the end of the resizing process. The processor 110 returns to step S13 after the processing of step S19.

Thus, the processor 110 functions as an example of the “controller that increases the width in the predetermined direction of at least one display area other than the hidden display area,” by performing the processing of step S54 once or more in the resizing process. In addition, the processor 110 functions as an example of the “controller that increases the widths in the predetermined direction of a plurality of display areas other than the hidden display area,” by performing the processing of step S54 twice or more in the resizing process.

In addition, the processor 110 functions as an example of the “controller that increases the width in the predetermined direction of the at least one display area other than the hidden display area such that a total amount of increase in the width in the predetermined direction of the at least one display area is equal to the width in the predetermined direction of the hidden display area,” by performing the resizing process using the determination of (C2). In addition, the processor 110 functions as an example of the “controller that increases the widths in the predetermined direction of the plurality of display areas other than the hidden display area such that a total amount of increase in the widths in the predetermined direction of the plurality of display areas is equal to the width in the predetermined direction of the hidden display area,” by performing the processing of step S54 twice or more in the resizing process using the determination of (C2).

Incidentally, the processor 110 may change the order of arrangement of the boxes BX in the resizing process. The processor 110 functions as an example of the “controller that increases the widths in the predetermined direction of the plurality of display areas other than the hidden display area without changing the order of arrangement of the plurality of display areas from the order before the display area is hidden,” by performing the resizing process without changing the order of arrangement of the boxes BX.

In the display system 1 according to the present embodiment, the bedside monitor 100 displays a plurality of display size candidates for biological information selected by the operator or the like. Then, the bedside monitor 100 according to the embodiment displays a box of a display size specified by the first operation, in such a manner that the box aligns to the grid on the touch panel 150. Because the bedside monitor 100 displays display size candidates for biological information selected by the operator or the like as described above, the operator can check what size the biological information can be displayed on the screen of the bedside monitor 100. In addition, as described above, the bedside monitor 100 can present the biological information to the operator in an easily recognizable manner. This makes it easy for the operator to visualize a display mode of the biological information to be newly added. Hence, the operator can easily and efficiently perform a display setting process of displaying the desired biological information in a desired layout. In addition, the bedside monitor 100 can prevent the operator from making an erroneous operation and an erroneous setting.

In addition, in the display system 1 according to the present embodiment, the bedside monitor 100 hides any one of a plurality of boxes BX arranged vertically. Then, the bedside monitor 100 according to the present embodiment increases the vertical width of a box in the same column as the hidden box BX. The bedside monitor 100 according to the present embodiment can thereby reduce a blank within the area AR2. In addition, the bedside monitor 100 according to the present embodiment can facilitate the viewing of biological information in a box BX by increasing the vertical width of the box BX.

In addition, in the display system 1 according to the present embodiment, the bedside monitor 100 increases the vertical widths of a plurality of boxes BX in the same column as the hidden box BX. There is consequently a possibility that the bedside monitor 100 according to the present embodiment can reduce a blank within the area AR2, compared with the case of increasing the vertical width of one box BX. In addition, the bedside monitor 100 according to the present embodiment can facilitate the viewing of biological information in a plurality of boxes BX by increasing the vertical widths of the plurality of boxes.

In addition, in the display system 1 according to the present embodiment, the bedside monitor 100 increases the vertical width of boxes without changing the order of arrangement of the boxes. The bedside monitor 100 according to the embodiment can thereby prevent the operator or the like from mistakenly viewing biological information due to the change in order.

In addition, in the display system 1 according to the present embodiment, when a communication cable 300 is disconnected from the bedside monitor 100, the bedside monitor 100 hides a corresponding box BX. The corresponding box BX is a box that displays biological information acquired via the relevant communication cable 300. When the communication cable 300 is disconnected from the bedside monitor 100, it can be estimated that the communication cable 300 is removed intentionally. When biological information is not able to be acquired even though the communication cable 300 is not disconnected, on the other hand, there is a strong possibility of being unexpectedly unable to acquire the biological information, as compared with the case where the communication cable 300 is disconnected from the bedside monitor 100. The case of being unexpectedly unable to acquire the biological information is, for example, a case where the communication cable 300 is disconnected from the measuring device 200. Therefore, by hiding the box BX when the communication cable 300 is disconnected from the bedside monitor 100, the bedside monitor 100 can prevent the box BX from being hidden when the biological information is not able to be acquired unexpectedly.

In addition, in the display system 1 according to the present embodiment, the bedside monitor 100 makes a total increased vertical width equal to the vertical width of the hidden box BX. The bedside monitor 100 can thereby increase the vertical width of another box BX being displayed, by an amount corresponding to the hidden box BX, and can therefore reduce a blank area on the screen.

In addition, in the display system 1 according to the present embodiment, the bedside monitor 100 makes a total amount of increase in the vertical widths of a plurality of boxes equal to the vertical width of the hidden box. The bedside monitor 100 can thereby reduce a blank by an amount corresponding to the hidden box and prevent only one box from becoming too large.

In addition, in the display system 1 according to the present embodiment, the bedside monitor 100 displays the model image IM41a or the model image IM41b as a display area model. The bedside monitor 100 can thereby make display size candidates more easily recognizable than in a case where the candidates are displayed merely as text.

In addition, in the display system 1 according to the present embodiment, the bedside monitor 100 displays the model image IM41a including a real-time display of biological information. Thus, the operator can select a display size of a box BX to be newly arranged, while actually viewing a measured value or a waveform of the biological information. In addition, the operator can appropriately select a display size while referring to the measured value or the waveform in real time.

In addition, in the display system 1 according to the present embodiment, the bedside monitor 100 displays the setting area AR4a on the waveform area AR22 for displaying waveform boxes BX2. Thus, when the arrangement of a measured value box BX1 is set, the bedside monitor 100 can prevent the hiding of the measured value area AR21 for displaying the measured value box BX1. Hence, the operator can change the display setting of the measured value area AR21 while constantly checking the measured value(s) of one kind or two or more kinds of biological information displayed in the measured value area AR21 and thus recognizing the state of a patient.

In addition, in the display system 1 according to the present embodiment, when the measured value area AR21 displaying the measured value(s) of biological information is operated, the bedside monitor 100 displays the setting area AR4a for changing the display setting of the measured value(s) of the biological information. The operator can thereby start an operation of changing the setting of the measured value(s) of the biological information through an intuitive operation.

In addition, in the display system 1 according to the present embodiment, the bedside monitor 100 displays the setting area AR4b on the measured value area AR21 for displaying measured value boxes BX1. Thus, when the arrangement of a waveform box BX2 is set, the bedside monitor 100 can prevent the hiding of the waveform area AR22 for displaying the waveform box BX2. Hence, the operator can change the display setting of the waveform area AR22 while constantly checking the waveform(s) of one kind or two or more kinds of biological information displayed in the waveform area AR22 and thus recognizing the state of a patient.

In addition, in the display system 1 according to the present embodiment, when the waveform area AR22 displaying the waveform(s) of biological information is operated, the bedside monitor 100 displays the setting area AR4b for changing the display setting of the waveform(s) of the biological information. The operator can thereby start an operation of changing the setting of the waveform(s) of the biological information through an intuitive operation.

In addition, in the display system 1 according to the present embodiment, the first operation includes input that specifies a display size of a box. The operator or the like can specify the display size by using a starting point of a drag operation and therefore perform an intuitive operation.

In addition, in the display system 1 according to the present embodiment, the bedside monitor 100 displays the model area AR6 including a real-time display of biological information, in such a manner that the model area AR6 follows a drag operation. This makes it easy for the operator or the like to visualize how a box BX is to be displayed. In addition, the operator can specify the position of a box BX to be newly arranged, while actually viewing a measured value or a waveform of the biological information. In addition, the operator can specify the position appropriately while referring to the measured value or the waveform in real time.

In addition, in the display system 1 according to the present embodiment, when another box BX is already arranged at the specified position, the bedside monitor 100 deletes or moves the box BX already arranged or changes a display size thereof. Thus, even when another box BX is already arranged at the specified position, the bedside monitor 100 according to the embodiment can suitably arrange a new box BX at the specified position.

In addition, in the display system 1 according to the present embodiment, the model area AR6a displays a reduced-size image of a measured value box BX1. In addition, the model area AR6b in the present embodiment displays a reduced-size image of a waveform box. Displaying a reduced-size image in this manner facilitates the recognition of the position and facilitates the arrangement in an intended area.

According to the present disclosure, the following configurations can be provided.

(1)

A medical device including:
a controller configured to
   receive first input that specifies biological information to be displayed on a screen,
   display, on the screen, a plurality of display size candidates corresponding to the biological information specified by the first input,
   receive second input that specifies one display size from the plurality of display size candidates,
   arrange, on the screen, a display area of the display size specified by the second input, in such a manner that the display area aligns to a grid set in advance, and
   display the biological information specified by the first input within the display area.
      (2)

The medical device according to (1), in which
the display area is configured to have a quadrangular shape, and
the controller is configured to
   arrange a plurality of the display areas displaying the biological information, side by side in a predetermined direction within the screen,
   hide a display area for which the biological information is not able to be acquired among the plurality of display areas, and
   increase a width in the predetermined direction of at least one display area other than the hidden display area.
      (3)

The medical device according to (2), in which
three or more of the display areas displaying the biological information are configured to be arranged side by side in the predetermined direction, and
the controller is configured to increase widths in the predetermined direction of a plurality of the display areas other than the hidden display area.
   (4)

The medical device according to (3), in which
the controller is configured to increase the widths in the predetermined direction of the plurality of display areas other than the hidden display area without changing an order of arrangement of the plurality of display areas from an order before the display area is hidden.
   (5)

The medical device according to any one of (2) to (4), in which
the controller is configured to
   acquire the biological information via a communication cable connected to the medical device, and
   hide the display area for which the biological information is not able to be acquired due to a disconnection of the communication cable from the medical device.
      (6)

The medical device according to any one of (2) to (5), in which
the controller is configured to increase the width in the predetermined direction of the at least one display area other than the hidden display area such that a total amount of increase in the width in the predetermined direction of the at least one display area is equal to a width in the predetermined direction of the hidden display area.
   (7)

The medical device according to (3), in which
the controller is configured to increase the widths in the predetermined direction of the plurality of display areas other than the hidden display area such that a total amount of increase in the widths in the predetermined direction of the plurality of display areas is equal to a width in the predetermined direction of the hidden display area.
   (8)

The medical device according to any one of (1) to (7), in which
the controller is configured to display a plurality of first display area models corresponding to a plurality of display sizes, as the plurality of display size candidates on the screen.
   (9)

The medical device according to (8), in which
each of the plurality of first display area models is configured to include a real-time display of the biological information specified by the first input.
   (10)

The medical device according to any one of (1) to (9), in which
the screen is configured to include a first area that displays a measured value of the biological information and a second area that displays a waveform of the biological information, and
in response to third input that specifies the measured value as the biological information to be displayed on the screen, the controller is configured to display a third area in a state of being superposed on the second area, the third area including the plurality of display size candidates corresponding to the measured value of the biological information specified by the first input, or to display the third area in a space vacated by reducing at least one of the first area or the second area.
   (11)

The medical device according to (10), in which
the third input includes an operation made on an inside of the first area.
   (12)

The medical device according to any one of (1) to (11), in which
the screen is configured to include a first area that displays a measured value of the biological information and a second area that displays a waveform of the biological information, and
in response to fourth input that specifies the waveform as the biological information to be displayed on the screen, the controller is configured to display a fourth area in a state of being superposed on the first area, the fourth area including the plurality of display size candidates corresponding to the waveform of the biological information specified by the first input, or to display the fourth area in a space vacated by reducing at least one of the first area or the second area.
   (13)

The medical device according to (12), in which
the fourth input includes an operation made on an inside of the second area.
   (14)

The medical device according to any one of (1) to (13), in which
the second input includes input that specifies the display size by using a starting point of a drag operation, and
the controller is configured to arrange the display area of the display size specified by the drag operation, at an end point of the drag operation.
   (15)

The medical device according to (14), in which
the controller is configured to display a second display area model corresponding to the display size specified by the drag operation, in such a manner that the second display area model follows the drag operation, the second display area model including a real-time display of the biological information specified by the first input.
   (16)

The medical device according to any one of (1) to (15), in which,
in an event that another display area is already arranged at a position where the display area is to be arranged, the controller is configured to delete or move the other display area, or change a display size of the other display area.
   (17)

A display setting method performed by a medical device, the method including:
receiving first input that specifies biological information to be displayed on a screen;
displaying, on the screen, a plurality of display size candidates corresponding to the biological information specified by the first input;
receiving second input that specifies one display size from the plurality of display size candidates;
arranging, on the screen, a display area of the display size specified by the second input, in such a manner that the display area aligns to a grid set in advance; and
displaying the biological information specified by the first input within the display area.

The embodiment of the present disclosure has been described above with reference to the accompanying drawings. However, it is needless to say that the present disclosure is not limited to such an embodiment. It is apparent that those skilled in the art can conceive various kinds of altered examples or modified examples within the scope of the claims. It is therefore to be understood that these examples also naturally fall within the technical scope of the present disclosure.

It is to be noted that steps in the display setting method according to the present disclosure do not necessarily need to be performed in time series according to the order described in the flowchart, and may include parallel processing or processing of a subroutine.

The foregoing embodiment is also susceptible of the following modifications.

As with the areas AR44a, the areas AR44b may each include a reduced-size image of a waveform box BX2 with a display size corresponding to the area AR44b. In addition, the image may include a real-time display of a waveform. The image may include a real-time display of information other than the waveform.

In the foregoing embodiment, the model area AR6b does not display a waveform or the like but represents the external shape thereof. However, as with the model area AR6a, the model area AR6b may display a full-size image or a reduced-size image of a waveform box BX2 including display contents. In addition, the model area AR6b may include a real-time display of a waveform. The model area AR6b may include a real-time display of information other than the waveform.

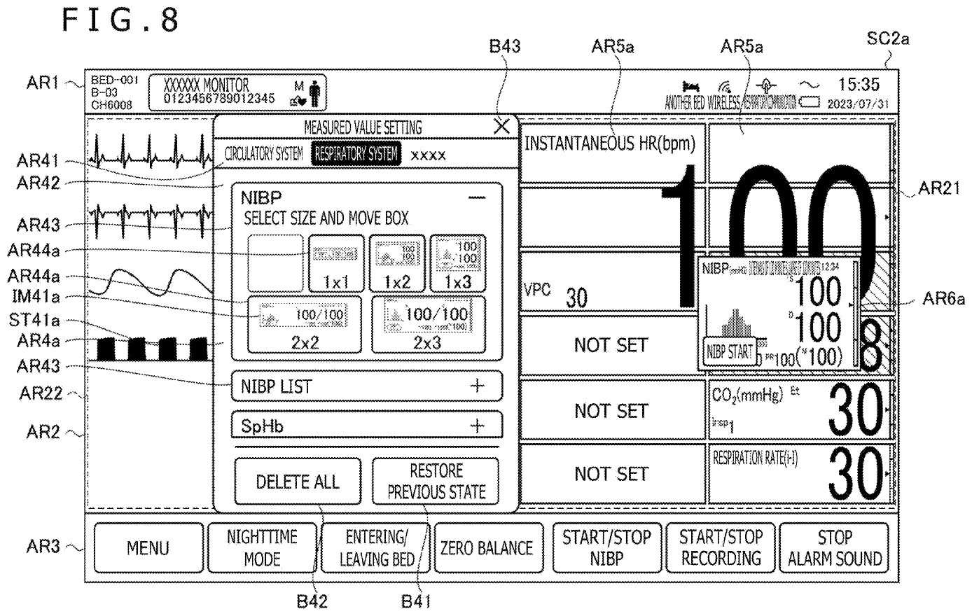

In the foregoing embodiment, the processor 110 of the bedside monitor 100 displays the setting area AR4a in a state of being superposed on the waveform area AR22 as illustrated in FIG. 6, in step S31 of FIG. 3 in the numerical value addition process. However, as illustrated in FIG. 8, the processor 110 may reduce at least one of the measured value area AR21 or the waveform area AR22 (change the display size thereof). Then, as illustrated in FIG. 8, the processor 110 may display the setting area AR4a in a space vacated by the reduction. FIG. 8 is a diagram illustrating an example of the setting screen SC2a displayed on the touch panel 150. FIG. 8 illustrates an example in which the setting area AR4a is displayed in a space vacated by reducing the horizontal width of each of the measured value area AR21 and the waveform area AR22. In addition, in the example of FIG. 8, the processor 110 also reduces the horizontal width of the model area AR6a at the same ratio as that of the measured value area AR21. Incidentally, the processor 110 may reduce at least one of the measured value area AR21 or the waveform area AR22 without maintaining the aspect ratio thereof, or may reduce at least one of the measured value area AR21 or the waveform area AR22 while maintaining the aspect ratio thereof. In addition, the setting area AR4a may overlap the measured value area AR21 to such a degree as not to hide the measured values. The setting area AR4a may overlap the waveform area AR22 to such a degree as not to hide the waveforms. Thus, when the arrangement of a measured value box BX1 is set, the bedside monitor 100 can prevent the measured value area AR21 for displaying the measured value box BX1 from being hidden. In addition, the bedside monitor 100 can also prevent the waveform area AR22 from being hidden. Incidentally, the processor 110 functions as an example of the “controller that displays the third area in a space vacated by reducing at least one of the first area and the second area,” by performing the above processing.

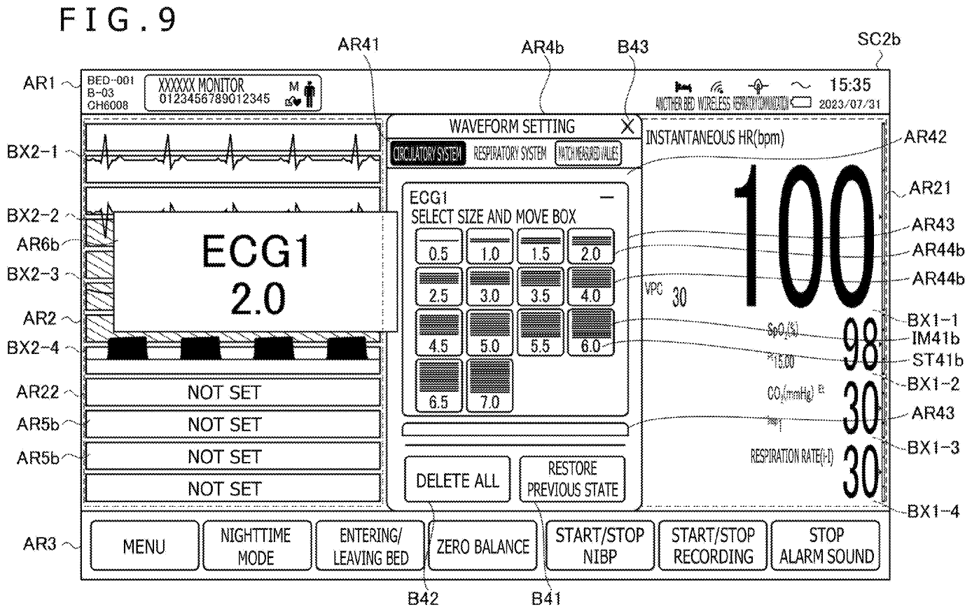

In the foregoing embodiment, the processor 110 of the bedside monitor 100 displays the setting area AR4b in a state of being superposed on the measured value area AR21 as illustrated in FIG. 7, in step S31 of FIG. 3 in the waveform addition process. However, as illustrated in FIG. 9, the processor 110 may reduce at least one of the measured value area AR21 or the waveform area AR22 (change the display size thereof). Then, as illustrated in FIG. 9, the processor 110 may display the setting area AR4b in a space vacated by the reduction. FIG. 9 is a diagram illustrating an example of the setting screen SC2b displayed on the touch panel 150. FIG. 9 illustrates an example in which the setting area AR4b is displayed in a space vacated by reducing the horizontal width of the measured value area AR21. In the present example, the processor 110 does not reduce the waveform area AR22. Incidentally, the processor 110 may reduce at least one of the measured value area AR21 or the waveform area AR22 without maintaining the aspect ratio thereof, or may reduce at least one of the measured value area AR21 or the waveform area AR22 while maintaining the aspect ratio thereof. In addition, the setting area AR4b may overlap the measured value area AR21 to such a degree as not to hide the measured values. The setting area AR4b may overlap the waveform area AR22 to such a degree as not to hide the waveforms. Thus, when the arrangement of a waveform box BX2 is set, the bedside monitor 100 can prevent the waveform area AR22 for displaying the waveform box BX2 from being hidden. In addition, the bedside monitor 100 can also prevent the measured value area AR21 from being hidden. Incidentally, the processor 110 functions as an example of the “controller that displays the fourth area in a space vacated by reducing at least one of the first area and the second area,” by performing the above processing.

Incidentally, when the processor 110 reduces at least one of the measured value area AR21 or the waveform area AR22, the processor 110 may decide which of the measured value area AR21 and the waveform area AR22 to reduce, according to the target of the addition process. The processor 110 preferably reduces the area that displays either the measured values or the waveforms that are not the target of the addition process. That is, in the numerical value addition process, the processor 110 reduces the waveform area AR22, but does not reduce the measured value area AR21. Then, the processor 110 displays the setting area AR4a in a vacated space. In addition, in the waveform addition process, the processor 110 reduces the measured value area AR21, but does not reduce the waveform area AR22. Then, the processor 110 displays the setting area AR4b in a vacated space. When the processor 110 thus reduces only one of the measured value area AR21 and the waveform area AR22, the processor 110 reduces the horizontal width thereof, for example.

The measured value box BX1 may be capable of displaying measured values of information other than biological information. The waveform box BX2 may be capable of displaying waveforms of information other than biological information. The boxes BX may be capable of displaying information other than biological information.

In the foregoing embodiment, the first operation is a press operation in drag and drop. However, the first operation may be any other operation. The other operation is, for example, a click, a tap, or the like. However, in a case where the first operation is the other operation, the processor 110 omits the processing of step S38 and proceeds to step S39.

In the foregoing embodiment, the second operation is a drop operation in drag and drop. However, the second operation may be any other operation. The other operation is, for example, a click, a tap, or the like.

When another box is already arranged at the specified position, the processor 110 may not arrange a box BX at the specified position.

The processor 110 of the bedside monitor 100 may be capable of performing display setting cancellation processing (step S44 in FIG. 3) a plurality of times. The processor 110 may be capable of performing processing of making again a display setting which has been once canceled. This processing is referred to also as redoing.

In the foregoing embodiment, when a communication cable 300 is disconnected from the connector 161, the processor 110 hides a box BX displaying biological information acquired via the relevant communication cable 300. However, the processor 110 may hide a box BX displaying biological information, when the biological information is not able to be acquired for another reason. In addition, the processor 110 may hide a box BX in response to input that specifies the hiding of the box BX.

In the foregoing embodiment, the processor 110 performs the resizing process of changing the display size of a box BX in the same column as the box BX hidden in step S18. However, the processor 110 may perform a resizing process of changing the display size of a box BX in the same row as the box BX hidden in step S18. Here, the row refers to a sequence in the horizontal direction. In the case of performing the resizing process of changing the display size of a box BX in the same column as the box BX hidden in step S18, the vertical direction is an example of the predetermined direction. On the other hand, in the case of performing the resizing process of changing the display size of a box BX in the same row as the box BX hidden in step S18, the horizontal direction is an example of the predetermined direction.

The area AR2 may not be divided into the measured value area AR21 and the waveform area AR22. In this case, the whole of the area AR2 may allow arrangement of both the measured value boxes BX1 and the waveform boxes BX2.

In the foregoing embodiment, the vertical width of the box BX is not limited to an integral multiple of the row height of the grid. Moreover, the horizontal width of the box BX is not limited to an integral multiple of the column width of the grid. However, the vertical width of the box BX may be limited to an integral multiple of the row height of the grid. In addition, the horizontal width of the box BX may be limited to an integral multiple of the column width of the grid. In a case where the vertical width and the horizontal width of the box BX are limited to integral multiples of the row height and the column width of the grid, the grid is minimum units of the display areas for displaying boxes BX.

In the foregoing embodiment, the bedside monitor 100 has been described as an example of the medical device according to the present disclosure. However, the medical device according to the present disclosure may be a medical device other than the bedside monitor 100. Examples of the medical device other than the bedside monitor 100 include a central monitor, a spot check monitor, and any other terminal device used by a medical worker. In addition, the medical device according to the present disclosure may be a general-purpose device such as a server, a personal computer (PC), or a smart phone in which a program that can implement the processing according to the foregoing embodiment is installed.

The present disclosure is intended for medical devices by way of example. However, the present disclosure is also applicable to cases where devices other than the medical devices are used in place of the medical devices.

The medical device according to the present disclosure may be capable of displaying biological information of a plurality of patients.

The medical device according to the present disclosure may be capable of displaying a plurality of display screens SC1 within one touch panel 150. For example, the respective display screens SC1 may correspond to different patients.

The measuring device 200 may be capable of measuring information other than biological information.

Each device in the present disclosure may be constituted by a plurality of devices. Each device in the present disclosure may be implemented by using cloud computing.

The processor 110 may implement a part or the whole of the processing implemented by a program in the foregoing embodiment, by a hardware configuration of a circuit.

The program for implementing the processing in the embodiment is transferred in a state of being stored on a non-transitory computer readable storage medium within a device, for example. However, the device may be transferred in a state of not storing the program. Then, the program may be transferred separately and written to the device. The transfer of the program at this time can be implemented by, for example, recording the program on a removable non-transitory computer readable storage medium or downloading the program via a network such as the Internet or a local area network (LAN).

The present disclosure can make it possible to check what size biological information can be displayed.

What is claimed is:

1. A medical device comprising:
a controller configured to
receive first input that specifies biological information to be displayed on a screen,
display, on the screen, a plurality of display size candidates corresponding to the biological information specified by the first input,
receive second input that specifies one display size from the plurality of display size candidates,
arrange, on the screen, a display area of the display size specified by the second input, in such a manner that the display area aligns to a grid set in advance, and
display the biological information specified by the first input within the display area.

2. The medical device according to claim 1, wherein
the display area is configured to have a quadrangular shape, and
the controller is configured to
arrange a plurality of the display areas displaying the biological information, side by side in a predetermined direction within the screen,
hide a display area for which the biological information is not able to be acquired among the plurality of display areas, and
increase a width in the predetermined direction of at least one display area other than the hidden display area.

3. The medical device according to claim 2, wherein
three or more of the display areas displaying the biological information are configured to be arranged side by side in the predetermined direction, and
the controller is configured to increase widths in the predetermined direction of a plurality of the display areas other than the hidden display area.

4. The medical device according to claim 3, wherein
the controller is configured to increase the widths in the predetermined direction of the plurality of display areas other than the hidden display area without changing an order of arrangement of the plurality of display areas from an order before the display area is hidden.

5. The medical device according to claim 2, wherein
the controller is configured to
acquire the biological information via a communication cable connected to the medical device, and
hide the display area for which the biological information is not able to be acquired due to a disconnection of the communication cable from the medical device.

6. The medical device according to claim 2, wherein
the controller is configured to increase the width in the predetermined direction of the at least one display area other than the hidden display area such that a total amount of increase in the width in the predetermined direction of the at least one display area is equal to a width in the predetermined direction of the hidden display area.

7. The medical device according to claim 3, wherein
the controller is configured to increase the widths in the predetermined direction of the plurality of display areas other than the hidden display area such that a total amount of increase in the widths in the predetermined direction of the plurality of display areas is equal to a width in the predetermined direction of the hidden display area.

8. The medical device according to claim 1, wherein
the controller is configured to display a plurality of first display area models corresponding to a plurality of display sizes, as the plurality of display size candidates on the screen.

9. The medical device according to claim 8, wherein
each of the plurality of first display area models is configured to include a real-time display of the biological information specified by the first input.

10. The medical device according to claim 1, wherein
the screen is configured to include a first area that displays a measured value of the biological information and a second area that displays a waveform of the biological information, and
in response to third input that specifies the measured value as the biological information to be displayed on the screen, the controller is configured to display a third area in a state of being superposed on the second area, the third area including the plurality of display size candidates corresponding to the measured value of the biological information specified by the first input, or to display the third area in a space vacated by reducing at least one of the first area or the second area.

11. The medical device according to claim 10, wherein
the third input comprises an operation made on an inside of the first area.

12. The medical device according to claim 1, wherein
the screen is configured to include a first area that displays a measured value of the biological information and a second area that displays a waveform of the biological information, and
in response to fourth input that specifies the waveform as the biological information to be displayed on the screen, the controller is configured to display a fourth area in a state of being superposed on the first area, the fourth area including the plurality of display size candidates corresponding to the waveform of the biological information specified by the first input, or to display the fourth area in a space vacated by reducing at least one of the first area or the second area.

13. The medical device according to claim 12, wherein
the fourth input comprises an operation made on an inside of the second area.

14. The medical device according to claim 1, wherein
the second input comprises input that specifies the display size by using a starting point of a drag operation, and
the controller is configured to arrange the display area of the display size specified by the drag operation, at an end point of the drag operation.

15. The medical device according to claim 14, wherein
the controller is configured to display a second display area model corresponding to the display size specified by the drag operation, in such a manner that the second display area model follows the drag operation, the second display area model including a real-time display of the biological information specified by the first input.

16. The medical device according to claim 1, wherein,
in an event that another display area is already arranged at a position where the display area is to be arranged, the controller is configured to delete or move the other display area, or change a display size of the other display area.

17. A display setting method performed by a medical device, the method comprising:
receiving first input that specifies biological information to be displayed on a screen;
displaying, on the screen, a plurality of display size candidates corresponding to the biological information specified by the first input;
receiving second input that specifies one display size from the plurality of display size candidates;
arranging, on the screen, a display area of the display size specified by the second input, in such a manner that the display area aligns to a grid set in advance; and
displaying the biological information specified by the first input within the display area.
